(19) United States
(12) Patent Application Publication
(10) Pub. No.: US 2011/0075416 A1
(43) Pub. Date: Mar. 31, 2011

(54) LED illumination device having two sides illumination

(76) Inventors: Meng Hsieh Chou, Sinjhuang City (TW); Yen Wei Pen, Sinjhuang City (TW); Ming Xian Lin, Sinjhuang City (TW); Yen Chi Wu, Sinjhuang City (TW)

(21) Appl. No.: 12/703,772

(22) Filed: Feb. 11, 2010

(30) Foreign Application Priority Data
Sep. 25, 2009 (TW) 098132380

(51) Int. Cl. F21V 1/00; F21V 29/00

(52) U.S. Cl. 362/235; 362/373

(57) ABSTRACT

An LED illumination device having two sides illumination includes a heat sink base, two LED illumination modules and two transparent boards. The heat sink base has a first heat sink base, a second heat sink base and a connecting element connected the first heat base and second heat sink base, wherein the first heat sink base is formed with a first accommodating space, the second heat sink base is formed with a second accommodating space opposite to the first accommodating space. The two LED illumination modules are mounted on the first accommodating space and the second accommodating space of the heat sink base respectively. And the two transparent boards are mounted on the first accommodating and the second accommodating space of the heat sink base to cover the two LED illumination modules.

### FIELD OF THE INVENTION

The present invention relates to an LED illumination device having two sides illumination, and in particular to an LED illumination device capable of enhancing brightness of illumination.

### DESCRIPTION OF THE RELATED ART

Since light emitting diodes (LEDS) feature the high brightness, power saving and long life expectancy advantages, they have been used extensively for the illumination of lamps. Several LED lamps are usually connected to form an LED lamp set, and the position of each lamp can be adjusted to achieve an illumination effect to meet the requirements for a large projecting area and a high brightness. These LED lamp sets are used as illuminating devices indoors and outdoors. However, it is necessary to plan the LED lamps and the layout of different projecting areas, so as to differentiate the projecting area for each LED lamp with a different distance from the LED lamp and the projecting area, and prevent an uneven brightness of the light projected from the LED lamps onto the projecting areas. Therefore, it is an important subject for manufacturers in the related field to design an LED lamp with good directionality and even brightness.

As is generally known in the art, use has been made of varying kinds of illumination lamps for lightening or illuminating objects at night or indoors. Such illumination lamps are supplied with electric energy from a power source and convert the electric energy to light energy, thereby producing a beam of light for illumination. Typical examples of the illumination lamps include a glow lamp and a fluorescent lamp.

Widely used in recent years is a Light Emitting Diode (LED) illumination lamp that has a benefit of providing illumination of different colors, although higher in price than the typical lamps referred to above. However, the LED illumination lamp poses a drawback in that it tends to be heated up and shows decreased efficiency when used for more than a predetermined time period. Use of the LED lamp for a prolonged period of time may result in excessive heat generation, thus shortening the life span of the lamp.

### SUMMARY OF THE INVENTION

An object of the present invention is to provide an LED illumination device having two sides illumination capable of enhancing brightness of illumination.

To achieve the above-mentioned object, the present invention includes a heat sink base, two LED illumination modules and two transparent boards. The heat sink base has a first heat sink base, a second heat sink base and a connecting element connected the first heat base and second heat sink base, wherein the first heat sink base is formed with a first accommodating space, the second heat sink base is formed with a second accommodating space opposite to the first accommodating space. The two LED illumination modules are mounted on the first accommodating space and the second accommodating space of the heat sink base respectively. And the two transparent boards are mounted on the first accommodating and the second accommodating space of the heat sink base to cover the two LED illumination modules.

### BRIEF DESCRIPTION OF THE DRAWINGS

FIG. 1 is an exploded view of an LED illumination device having two sides illumination of the present invention

FIG. 2 is a cross-sectional view of assembly drawing of the FIG. 1.

FIG. 3 is a schematic drawing of the present invention.

### DETAILED DESCRIPTION OF THE INVENTION

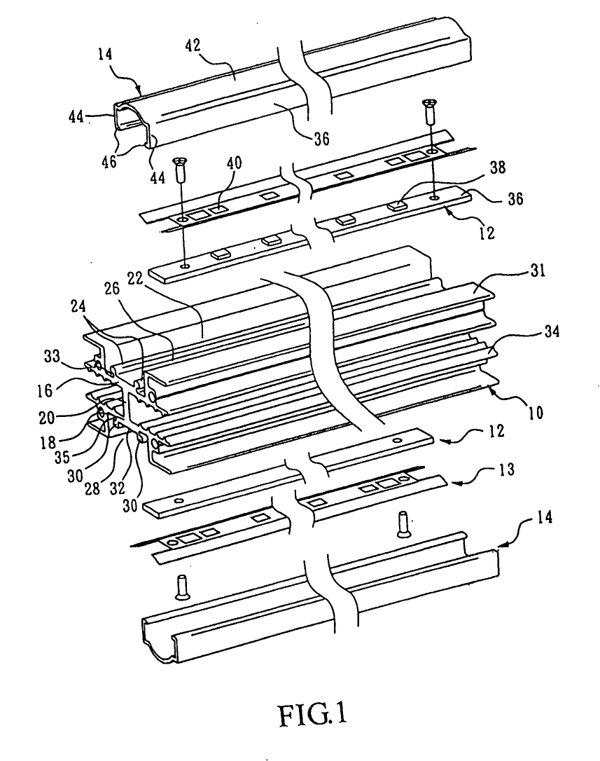

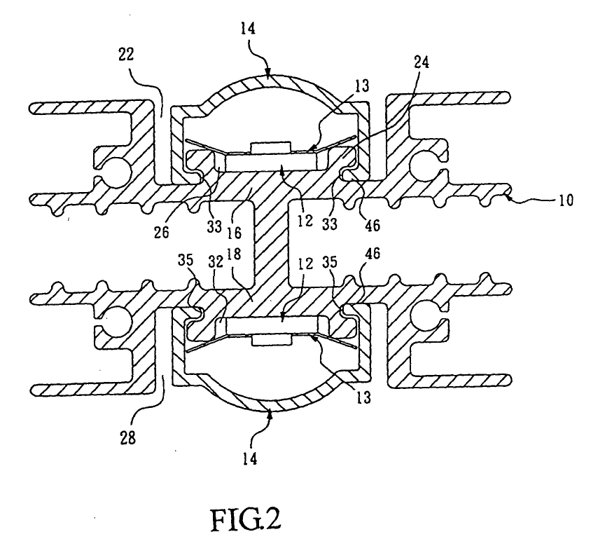

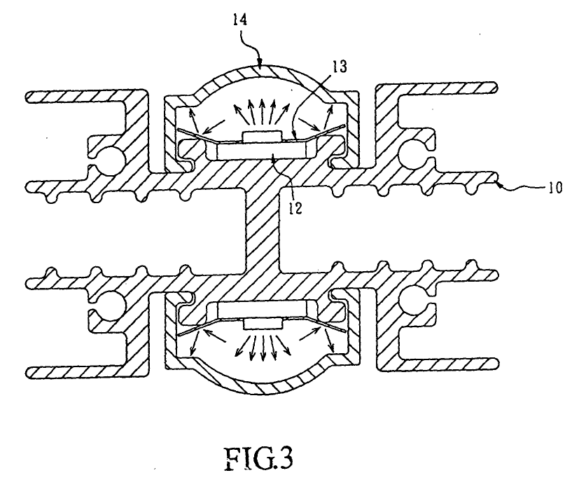

Referring to FIG. 1-FIG. 3, an LED illumination device having two sides illumination of the present invention includes a heat sink base 10 two LED illumination modules 12, two reflecting boards 13 and two transparent boards 14.

The heat sink base 10 has a first heat sink base 16, a second heat sink base 18 and a connecting element 20 connected the first heat base 16 and second heat sink base 18. Wherein the first heat sink base 16 is formed with a first accommodating space 22, which is formed with two first lugs 24, on which a first cavity 26 is formed. The second heat sink base 18 is formed with a second accommodating space 28 opposite to the first accommodating space 16, and the second accommodating space 28 is formed with two second lugs 30, on which a second cavity 32 is formed. The both sides of the first accommodating space 22 or the first heat sink base 16 are formed with first heat sink sheets 31 and first slots 33. The both sides of second accommodating space 28 of the second heat sink base 18 are formed with second heat sink sheets 34 and second slots 35.

The two LED illumination modules 12 are mounted on the first cavity 26 of the first accommodating space 22 and the second cavity 32 of the second accommodating space 2 of the heat sink base 10 respectively, each LED illumination module 12 has a printed circuit board 36 and LEDS arranged on the printed circuit board 36.

The two reflecting boards 13, which has a plurality of penetrated holes 40, the reflecting boards 13 is mounted on the printed circuit board 36 of each LED illumination module, so that the LEDS may be exposed through the penetrated holes 40.

The two transparent boards 14 are mounted on the first accommodating 22 and the second accommodating space 2 of the heat sink base 10 respectively to cover the two illumination modules 12. Each transparent board 14 has an [symbol] shape, which has a top board 42 and two side boards 44 arranged at the both sides of the top board 42, wherein the bottom end of each side board 44 is formed with guide rail 46 for guiding the slot 33 and slot 35 or the heat sink base 10, so as to the transparent boards 14 may covered the LED illumination modules 12 respectively

While the present has been described by way of an example and in terms of a preferred embodiment, it is to he understood that the invention is not limited to the disclosed embodiment. To the contrary, it is intended to cover various modifications. Therefore, the scope or the appended claims should be accorded the broadest interpretation so as to encompass all such modification.

What is claimed is:

1. An LED illumination device having two sides illumination comprising:
A heat sink base having a first heat sink base, a second heat sink base and a connecting element connected the first heat base and second heat sink base, wherein the first heat sink base is formed with a first accommodating space, the second heat sink base is formed with a second accommodating space opposite to the first accommodating space;
Two LED illumination modules being mounted on the first accommodating space and the second accommodating space of the heat sink base respectively, each LED illumination module has a printed circuit board and LED arranged on the printed circuit board; and
Two transparent boards being mounted on the first accommodating and the second accommodating space of the heat sink base respectively to cover the two illumination modules.

2. The LED illumination device having two sides illumination according to claim 1, wherein the first accommodating space of first heat sink base has two first lugs, on which a first cavity is formed, so as to the LED illumination module is located within the first cavity.

3. The LED illumination device having two sides illumination according to claim 1, wherein the second accommodating space of second heat sink base has two second lugs on which a second cavity is formed, so as to the LED illumination module is located within the first cavity.

4. The LED illumination device having two sides illumination according to claim 1, wherein the both sides of the first heat sink base are formed with first heat sink sheets.

5. The LED illumination device having two sides illumination according to claim 1, wherein the hath sides of the second heat sink base are formed with second heat sink sheets.

6. The LED illumination device having two sides illumination according to claim 1, furthering includes two reflecting boards, which are formed with penetrated holes corresponding the LEDS, and are mounted on the printed circuit board of the illumination modules respectively, so that the LEDS may he exposed through the penetrated holes.

7. The LED illumination device having two sides illumination according to claim 1, wherein each transparent hoard has a [symbol] shape, which has a top board and two side boards located at the both sides of the to board.

8. The LED illumination device having two sides illumination according to claim 1, wherein the both sides of first accommodating space of the first heat sink base are formed with first slots, the both sides of second accommodating space of the second heal sink base are formed with second slots.

9. The LED illumination device having two sides illumination according to claim 7, wherein the two side boards of the transparent board are formed with a guide rails respectively.
